(19) United States
(12) Patent Application Publication
(10) Pub. No.: US 2004/0103049 A1
(43) Pub. Date: May 27, 2004

(54) Fraud prevention system

(76) Inventor: Thomas F. Kerr, Quincy, FL (US)

Correspondence Address: Mark D. Passler, Akerman Senterfitt, P.O. Box 3188, West Palm Beach, FL, 33402-3188, US

(21) Appl. No.: 10/302,343

(22) Filed: Nov. 22, 2002

(51) Int. Cl. G06F 17/60

(52) U.S. Cl. 705/35

(57) ABSTRACT

A fraud prevention system for notifying subscribers of the system, which may be financial institutions; such as banks, brokerage houses, and credit unions; law enforcement agencies; retail stores; and others, of the occurrence of a fraudulent act so that the unaffected subscribers may take appropriate action to prevent the same perpetrator or other perpetrators from committing other fraudulent acts. The fraud prevention system includes a central operating system for receiving reports of fraudulent activity and making those reports available to subscribers of the system. The fraud prevention system also includes at least one display device for displaying the reports of fraudulent activity.

### FIELD OF THE INVENTION

This invention is directed generally to law enforcement and loss prevention systems, and more particularly, to fraud prevention systems for financial institutions, such as banks, law enforcement agencies, retail establishments and others.

### BACKGROUND

Financial fraud has accounted for great losses in monetary trade systems for years. Fraudulent acts have been perpetrated against financial institutions; such as banks, brokerage houses, and credit unions; retail establishments; and others. Fraudulent acts against banks include, but are not limited to, loan fraud, check fraud, new account fraud, counterfeit currency, and the like. Similar types of fraudulent acts are often committed against retail stores as well.

Fraudulent acts are committed by people from all walks of life, from unorganized, uneducated individuals to highly educated, networked individuals. Most often, commission of these fraudulent acts goes unreported, except in a police report. Unless multiple occurrences of fraud are committed within a particular geographic location by the same perpetrator, fraudulent acts are often not reported to similarly situated businesses. In the unlikely event that similarly situated businesses are notified of a fraudulent act or a pattern of fraudulent activity, the most common means of notifying those businesses is through a facsimile, newspaper, trade journal or other such publication. Thus, notification of the fraudulent acts often does not occur in a timely fashion. Rather, similarly situated businesses may not be notified until weeks or months after the occurrence of a fraudulent act.

In addition, most often these reports are confined to a particular industry. For instance, a notice of a fraudulent act may be disseminated within a law enforcement agency without also first being disseminated to the industry in which a member was the victim of a fraudulent act, or vice versa. Without such information, a company is more susceptible to being a victim. Thus, a need exists for a system of timely notifying individuals and organizations in the same industry and across industries of occurrences of fraudulent acts so that proper precautions may be instituted to thwart future fraudulent acts.

### SUMMARY OF THE INVENTION

This invention is directed to a fraud prevention system for warning subscribers of the fraud prevention system of fraudulent acts committed against a subscriber so that the other subscribers can take steps necessary to prevent a similar fraudulent act from occurring in the future. The subscribers of the fraud prevention system may be, but are not limited to, financial institutions; such as banks, brokerage houses, and credit unions; merchants; law enforcement agencies; and the like. The fraud prevention system includes one or more central operating systems for maintaining a list of a plurality of subscribers, receiving a plurality of reports of fraudulent activity from one or more subscribers, storing the reports of fraudulent activity, organizing the reports of fraudulent activity into categories, and generating alert messages for electronic transmission to at least one of the plurality of subscribers based on pre-determined criteria.

The fraud prevention system also includes at least one display device in electronic communication with the central operating system for displaying the reports of fraudulent acts and for enabling at least one subscriber to enter a report of a fraudulent act. The fraud prevention system can be operated using the Internet, a closed circuit communication system, a wireless communication system, or other computer system. The fraud prevention system may be accessed using electronic devices, such as, but not limited to, personal computers, personal digital assistants (PDAs), and other devices. The success of the system is based on participation by the subscribers by recording instances of fraudulent acts with the system. Without participation by the subscribers, the fraud prevention system does not have anything to report to the subscribers.

The fraud prevention system also includes a notification module for notifying subscribers when a report of a fraudulent act has been recorded. The subscribers may register to be notified by the fraud prevention system with an alert message each time a fraudulent act is recorded or according to pre-determined criteria. For instance, subscribers may elect to be only be notified of messages being recorded by particular individuals or institutions, by the type of fraudulent act committed, or other basis. Subscribers may be notified of a recorded message with an email message or other message.

The fraud prevention system also may include a fraud pattern detection module for analyzing recorded fraudulent acts. The fraud pattern detection module can identify similarities between reports of fraudulent activities and report patterns of fraud to the subscribers.

An advantage of this invention is that the fraud prevention system provides financial institutions and others with real time notification of fraudulent acts committed against other similar institutions so that the financial institutions may take necessary precautions to prevent similar fraudulent acts from occurring in the future.

Another advantage of this invention is that the fraud prevention system can automatically notify a subscriber that a fraudulent act has been recorded in the system without requiring that the subscriber first access the system. Thus, the subscriber is not required to constantly check the fraud prevention system to see if another subscriber has submitted a report of fraudulent activity. Rather, the subscriber need only have access to an email account or other form of electronic communication, such as, but not limited to, an autofax whereby a recipient of a facsimile may view the message electronically on, for instance, a personal computer.

Yet another advantage of this invention is that the fraud prevention system analyzes reports of fraudulent activity and notifies the subscribers of the fraud prevention system of patterns of fraudulent activity.

Another advantage of this invention is that the fraud prevention system provides the subscribers with access to the contact information of other subscribers so that the subscribers may contact each other to discuss instances of fraud, security issues, and other industry issues.

Still another advantage of this invention is that a report of a fraudulent act may be disseminated across industries, and more particularly, may be disseminated to law enforcement agencies and financial institutions using the same method of distribution.

These and other features and advantages of the present invention will become apparent after review of the following drawings and detailed description of the disclosed embodiments.

### BRIEF DESCRIPTION OF THE DRAWINGS

The accompanying drawings, which are incorporated in and form a part of the specification, illustrate preferred embodiments of the presently disclosed invention(s) and, together with the description, disclose the principles of the invention(s). These several illustrative figures include the following:

FIG. 1 is a schematic diagram of an example of an architectural support system of a fraud prevention system; and

FIG. 2 is a schematic diagram of the fraud prevention system.

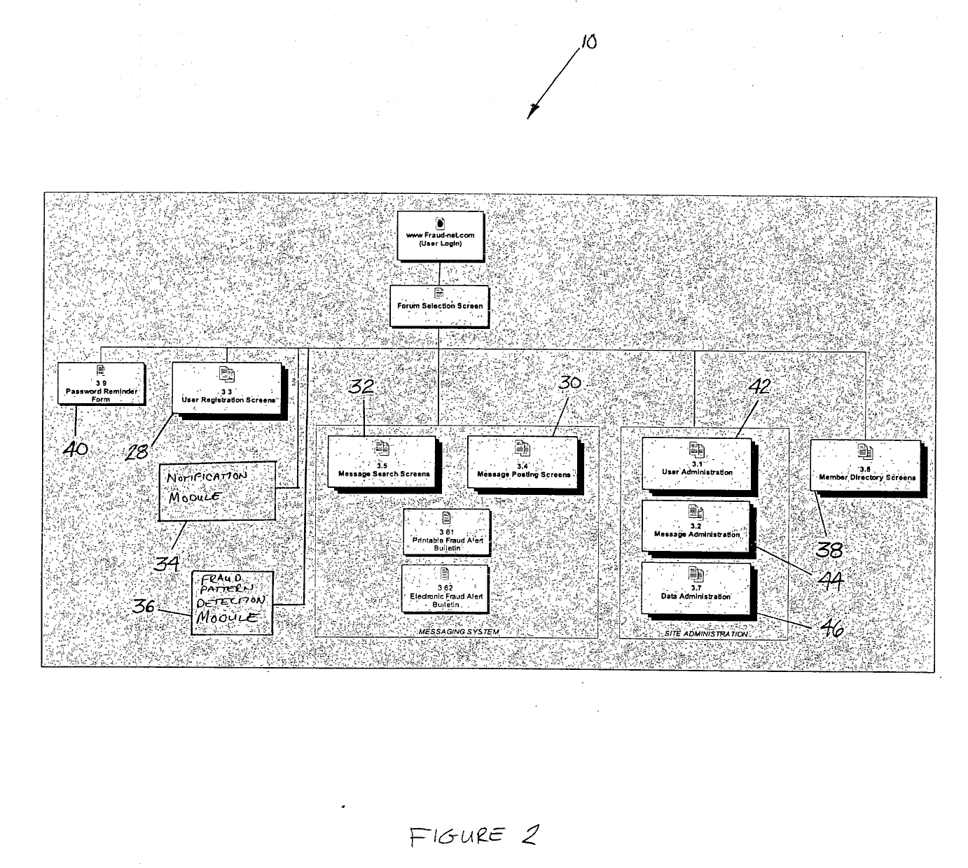

### DETAILED DESCRIPTION OF THE INVENTION

1. Definitions

A central operating system is any computer system capable of storing information electronically, such as, but not limited to, a server, a personal computer, a mainframe, and the like.

A display device is any device capable of displaying the information stored on the central operating system or capable of receiving information to be stored in the central operating system, or both.

A financial institution is any entity that provides financial services to individuals or corporations, such as, but not limited to, banks, credit unions, securities brokerage houses, and the like.

A fraudulent activity is any fraudulent act, such as, but not limited to, check fraud, loan fraud, new account fraud, counterfeit currency, merchandise return, rebate fraud, coupon fraud, and the like.

A subscriber is any individual, corporation or other entity that opens an account with the fraud prevention system.

2. Fraud Detection and Notification System

This invention relates to a fraud prevention system 10 for reducing fraudulent financial activity by individuals, corporations, and other entities with financial institutions and other organizations. The fraud prevention system 10 receives reports of fraudulent activity from subscribers and makes those reports, which may include text and video images, available to other subscribers. The video images may include still shots or streaming shots, or both. By making fraudulent activities known to other subscribers, those subscribers have the knowledge necessary to take preventive steps to thwart future fraudulent acts by the same perpetrators. The system may be configured to provide subscribers with real time information to increase the likelihood of preventing future fraudulent acts.

A. System Architecture

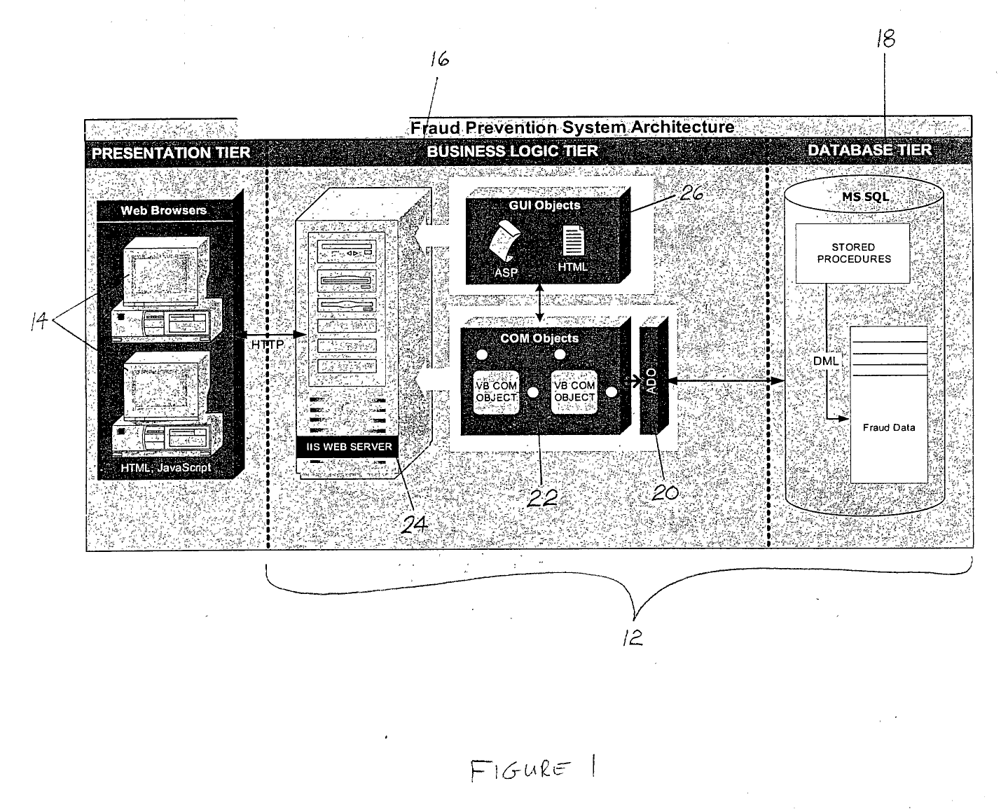

As shown in FIG. 1, the fraud prevention system 10 is stored on central operating system 12. Central operating system 12 is in electrical communication with one or more display devices 14 for allowing the subscribers to correspond with the fraud prevention system 10. Central operating system 12 may be coupled to display device 14 using the Internet, a closed circuit system, a wireless communication system, or other system. In one embodiment, as shown in FIG. 1, central operating system 12 includes a business logic tier 16 and a database tier 18. Database tier 18 includes memory for storing the modules described below. Database tier 18 communicates with ActiveX data objects (ADO) 20. ADO 20 communicates with at least one component object model (COM) 22 located in the business logic tier 16. COM 22 in turn communicates with a server 24, which may be a IIS web server. COM 22 also interfaces with a plurality of graphical user interfaces (GUI) 26. GUI 26 may be in the form of active server pages (ASP) or hypertext markup language (HTML). GUI 26 in turn interfaces with server 24, and server 24 interfaces with display devices 14 using hypertext transfer protocol (HTTP).

B. System Components

The fraud prevention system 10 includes many features for detecting patterns of fraudulent activity and for notifying subscribers of fraudulent activity. One embodiment of this invention is configured to be used with the financial industry, specifically the banking industry. However, the fraud prevention system 10 is not limited only to the banking industry. Rather, this system may be used with any industry, or across multiple industries, that are susceptible to fraud or interested in knowing about instances of fraud.

The fraud prevention system 10 includes numerous subparts for disseminating notice of fraudulent activity to subscribers. The fraud prevention system 10 may include a registration module, a message posting module, a message search module, a notification module, a fraud pattern detection module, a member directory module, a password module, a user administration module, a message administration module, and a data administration module. The fraud prevention system 10 also includes message board pages, message board search pages, data upload pages, and data download pages.

1) Registration Module

The registration module 28 enables a person, corporation, or other entity to become a subscriber of the fraud prevention system 10. The fraud prevention system 10 may or may not restrict who becomes a subscriber. In one embodiment, subscribers are limited to financial institutions, such as banks. However, in another embodiment, subscribers may include financial institutions, law enforcements agencies, financial industry institutions, retail stores, and others. Subscribers may or may not be required to pay a fee for participating in the fraud prevention system 10. In one embodiment where fees are required, subscribers may be required to pay fees annually, monthly, weekly, or according to another payment schedule.

The registration module 28 includes numerous pages that guide a person, corporation, or other entity through the registration process. The registration module 28 allows a subscriber to record information such as, but not limited to, their name, employer, position with that employer, address, telephone number, facsimile number, pager number and other information. The registration module may also allow a subscriber to pick a username and password. In another embodiment, the registration module 28 chooses a username and password for a subscriber. Information pertaining to a subscriber may be edited by the subscriber in a profile module after the registration process has been completed. In one embodiment, the profile module does not allow a subscriber to change the subscriber's address, or other information which indicates the geographic region with which the subscriber is associated.

In one embodiment, an applicant initiates the registration process by inputting information in appropriate locations in an electronic data input page. The potential subscriber submits the registration request by clicking an icon, striking the enter key, or through another action. The system generates a unique username and password or accepts or rejects the username and password submitted by the applicant. In one embodiment, a system administrator determines whether the applicant can become a subscriber. If the system administrator approves the applicant, then the applicant becomes a subscriber and is able to participate as an active member in the fraud prevention system 10.

2) Message Posting Module

The message posting module 30 enables a subscriber to record messages regarding fraudulent activities of the fraud prevention system 10. The purpose of the message posting module 30 is to enable a subscriber to record facts concerning a fraudulent act committed against the subscriber or another party. For instance, if the subscriber is a bank, the subscriber may record fraudulent activities such as, but not limited to, check fraud, loan fraud, new account fraud, or counterfeit currency. The subscriber may also record facts relevant to commission of the fraudulent act. In addition, investigative authorities may record fraudulent activities of which they are aware. In one embodiment, a subscriber may submit a message to be recorded; however, the message is not recorded and made available to other subscribers unless it is approved by a system administrator or other party. In another embodiment, a subscriber may be allowed to post a message, but upon review after posting, the posted message may be removed from the system.

In one embodiment, the subscriber is first prompted to enter information, such as, but not limited to, the subscriber's name, the subscriber's email address, indicate whether the fraudulent act is related to identification theft, an American Bankers Association (ABA) routing number, and a message. The subscriber may also record, which is also referred to as uploading, other relevant information to the fraud prevention system 10 such as, but not limited to, electronically stored documents. For instance, electronically stored documents may be, but are not limited to, photographs of perpetrators that may have been taken, for instance, with security cameras at an automated teller machine (ATM), service counter, or cashier checkout line; fingerprints; and other such documents. The subscriber may also enter information regarding the perpetrator such as, but not limited to, name, date of birth, social security number, gender, race, other identification, issuer of identification, issuing state, address, telephone number, cellular (mobile) phone number, pager number, alias, or other such information. Once entered, the fraud prevention system 10 saves the information in database tier 18. The subscriber or system administrator may edit any recorded information.

The recorded messages are organized into one or more threads. A thread is a folder designated to contain a particular type of message and is used to organize the messages so that messages pertaining to the same topic are grouped together. The recorded messages may be organized and displayed in a web page or through other electronic means. The recorded messages may be displayed on a page by listing the titles of the messages, the date the each message was recorded, the submitting subscribers, and hyperlinks connecting this page to the full text of each message.

3) Message Search Module

The message search module 32 enables subscribers to search messages that have been recorded in the fraud prevention system 10. Subscribers can search the recorded messages by entering search terms, such as words or phrases, into various search fields. Subscribers can search recorded messages by threads in which the messages are recorded, by keywords or other methods. More particularly, the subscribers can search by word or phrase in the message title or body, by submitting subscriber, author of posted message, ABA routing number, name, date of birth, social security number, state issuing identification, address, telephone number, cellular phone number, alias, attachment descriptions, or attachments, or an combination thereof. A subscriber may, if desired, search messages based on the date a message was recorded and may also restrict the search to messages recorded within a specified range of dates, or before or after a specified date.

When a search is conducted, the message search module 32 returns a list of messages matching the search criteria. The search results may be printed, electronically saved, or transmitted electronically, such as through electronic mail (email). The search may be modified if necessary.

4) Notification Module

The notification module 34 is capable of generating numerous alert messages notifying the subscribers of fraudulent activity. Subscribers can register with the fraud prevention system 10 to receive notifications, such as by email, when messages are recorded under particular threads, for particular types of fraud, or when messages are recorded by particular subscribers. For example, a subscriber can register with the fraud prevention system 10 to receive a notification each time a message is posted to a thread for loan fraud. The notification module 34 will generate and send a message to the subscriber each time a message is posted to the loan fraud thread. The message can include a hyperlink to the recorded message which enables a subscriber to view the recorded message describing a fraudulent act and any accompanying attachments, such as photographs or the perpetrator. When the subscriber activates the hyperlink, the subscriber can be prompted to enter a password before the subscriber can view the message.

5) Fraud Pattern Detection Module

The fraud pattern detection module 36 may analyze recorded messages of fraudulent activity and generates fraud alert bulletins that identify separate instances of recorded fraudulent activity that may be related to each other or identify a pattern of fraudulent activity. The fraud alert bulletins are generated in an effort to notify other subscribers of a pattern of fraud so that the subscribers may take necessary precautions to thwart the same perpetrator or other perpetrators from successfully committing similar fraudulent acts in the future. The fraud pattern detection module 36 analyzes each fraudulent act when it is entered into the fraud prevention system 10 and compares the report against previously recorded fraudulent acts. The fraud pattern detection module compares all recorded information, such as, the perpetrator's name, address, or alias. The fraud alert bulletins generated by the fraud pattern detection module 36 may identify the similarities between the fraud alert bulletins and provide a detailed summary of the analysis. Alternatively, the fraud alert bulletins may identify the instances of fraud without providing additional information.

Similarly, the fraud pattern detection module may produce robbery alert bulletins that are similar to the fraud alert bulletins, but include different amounts of information relative to the fraud alert bulletins. For instance, the robbery alert bulletins include photos of the perpetrator and other identifying information, but may not include information such as, but not limited to, the perpetrator's name and address.

6) Member Directory Module

The member directory module 38 contains the membership information for the subscribers. The member directory module 38 enables a subscriber to search for other members by institution, agency, name, job title, telephone number, email address, or other search term. The subscribers may or may not have the option of preventing or limiting the amount of information able to be viewed by other subscribers. The member directory module 38 enables subscribers to network with other subscribers and to contact other subscribers, if needed, to discuss common business concerns. The member directory module 38 may provide a subscriber information in a member profile popup window.

7) Password Module

The password module 40 secures the fraud prevention system 10 by preventing unauthorized parties from accessing the fraud prevention system 10 or from accessing particular parts of the fraud prevention system 10. The fraud prevention system 10 issues a password to each subscriber during the process of creating an account for the subscribers. The passwords are unique to each subscriber. A subscriber enters the password with the subscriber's user name to access the fraud prevention system 10. Each time a subscriber accesses the system, the password module 40 determines whether the subscriber has entered a correct password and either grants or rejects access to the fraud prevention system 10. A subscriber may change the password assigned to the subscriber if desired.

8) User Administration Module

The user administration module 42 interfaces with the registration module 28 to enable a system administrator to add, edit, and delete subscriber accounts. The system administrator can add or edit information in any part of any subscriber's account at the direction of a subscriber or on the administrator's own initiative. The system administrator may also delete information in a subscriber's account or may delete an entire account. The system administrator may delete a subscriber's account for numerous reasons, such as, but not limited to, failure to pay fees, inappropriate use of the fraud prevention system 10, and the like.

9) Message Administration Module

The message administration module 44 may allow a system administrator to approve or deny messages recorded by subscribers. Approved messages are available to be read by all subscribers, and denied messages are removed from the fraud prevention system 10. If a message is denied, the message administration module 44 prompts the system administrator to enter a reason for the denial. The reason for the denial of the message is then sent to the subscriber by email or other form of communication. An approved messages may include a hyperlink for the posting subscriber's profile, thereby giving other subscribers quick access to the posting subscriber's profile. The system administrator also may approve or deny multiple messages at one time.

10) Data Administration Module

The data administration module 46 enables a system administrator to upload or download batch files of data related to the reported fraudulent activities. In one embodiment, a system administrator is capable of uploading or downloading data on accounts that were closed due to fraud at a subscriber's institution. A system administrator may upload a page of data using an upload page. The data administration module 46 checks the upload file for any errors before uploading. If no errors are detected, the file is uploaded. Otherwise, the subscriber is notified of the errors present in the file and the file is prevented from being uploaded.

11) Exemplary Embodiments

The fraud prevention system 10 may be used by banks and law enforcement agencies to reduce the occurrence of fraudulent acts. Specifically, banks and law enforcement agencies may become subscribers of a fraud prevention system that may be organized and administered by a neutral third party, such as, but not limited to, a banking industry watchdog organization. In this embodiment, the banks and law enforcement agencies post messages describing fraudulent acts that were carried out against the banks. The fraud prevention system receives these messages and notifies other banks that fraudulent acts have taken place. The banks may then access the fraud prevention system 10 using, for instance, the Internet, to download detailed descriptions of each fraudulent act. Each description of a fraudulent act may include electronically stored documents, such as, but not limited to pictures of the perpetrator, fingerprints, copies of fraudulent identification cards or social security cards, and the like. Each bank may use this information to install necessary procedures to thwart future attempts of fraud.

In yet another embodiment, a system may be established that works as a hub and spoke system. More specifically, a fraud prevention system, such as one described above, may be employed in each of several states, provinces, or in other political boundaries. Each fraud prevention system in these states performs as the systems described above. A single master fraud prevention system could act as the hub for channeling communications between each of the fraud prevention systems in use in the individual states. The master fraud prevention system could receive notices of fraudulent schemes being carried out in one of the several states and disseminate this information to the remainder of the states so that the subscribing banks or each participant state can prevent such schemes from being implemented against them. The master fraud prevention can be used to transfer other information to the individual states as well.

The foregoing is provided for purposes of illustrating, explaining, and describing embodiments of this invention. Modifications and adaptations to these embodiments will be apparent to those skilled in the art and may be made without departing from the scope or spirit of this invention.

I claim:

1. A fraud prevention system, comprising:
at least one central operating system for:
maintaining a list of a plurality of subscribers;
receiving a plurality of reports of fraudulent activity from at least one subscribers;
storing the reports of fraudulent activity;
organizing the reports of fraudulent activity; and
generating at least one alert message for electronic transmission to at least one of the plurality of subscribers; and
at least one display device in electronic communication with the at least one central operating system for displaying the reports of fraudulent activity and allowing at least one subscriber to enter at least one report of fraudulent activity.

2. The fraud prevention system of claim 1, wherein generating at least one alert message further comprises identifying information common between a plurality of reports of fraudulent activity.

3. The fraud prevention system of claim 1, wherein generating at least one alert message occurs when the at least one central operating system receives a report of at least one fraudulent activity.

4. The fraud prevention system of claim 1, wherein the at least one alert message is sent to subscribers based on geographic location.

5. The fraud prevention system of claim 1, wherein the at least one alert message is sent to subscribers based on a type of fraudulent activity.

6. The fraud prevention system of claim 1, wherein the at least one central operating system is capable of receiving and storing information relating to the identity of the plurality of subscribers.

7. The fraud prevention system of claim 1, wherein the at least one central operating system is capable of receiving and storing information relating to the identity of a perpetrator accused of committing a fraudulent act.

8. The fraud prevention system of claim 7, wherein the information relating to the identity of the person committing a fraudulent act comprises electronically stored documents.

9. The fraud prevention system of claim 7, wherein the information relating to the identity of the person committing a fraudulent act comprises electronically stored pictures.

10. The fraud prevention system of claim 1, wherein the plurality of subscribers are financial institutions.

11. The fraud prevention system of claim 1, further comprising a search engine for locating information in the database.

12. The fraud prevention system of claim 11, wherein the search engine is capable of locating individuals suspected of committing fraudulent acts that meet selected criteria.

13. The fraud prevention system of claim 1, wherein the central operating system is coupled to the at least one display device through the Internet.

14. The fraud prevention system of claim 1, wherein the central operating system is coupled to the at least one display device through a closed circuit communications system.

15. The fraud prevention system of claim 1, wherein the fraudulent activity comprises check fraud.

16. The fraud prevention system of claim 1, wherein the fraudulent activity comprises loan fraud.

17. The fraud prevention system of claim 1, wherein the fraudulent activity comprises new account fraud.

18. The fraud prevention system of claim 1, wherein the fraudulent activity comprises counterfeit currency.

19. A method of preventing financial fraud, comprising:
maintaining a list of a plurality of subscribers on at least one central operating system;
receiving a plurality of electronic reports of fraudulent activity from at least one subscribers;
storing the reports of fraudulent activity in the at least one central operating system;
organizing the reports of fraudulent activity; and
generating at least one alert message for electronic transmission to at least one of the plurality of subscribers based on pre-determined criteria.

20. The method of claim 19, wherein generating at least one alert message further comprises identifying information common between a plurality of reports of fraudulent activity.

21. The method of claim 19, wherein generating at least one alert message occurs when the at least one central operating system receives a report of at least one fraudulent activity.

22. The method of claim 19, wherein the at least one alert message is sent to subscribers based on a geographic location.

23. The method of claim 19, wherein the at least one alert message is sent to subscribers based on the type of fraudulent activity.

24. The method of claim 19, further comprising approving the reports of fraudulent activity.
